(19) United States
(12) Patent Application Publication
(10) Pub. No.: US 2012/0290665 A1
(43) Pub. Date: Nov. 15, 2012

(54) SYSTEMS AND METHODS FOR CHANGING APPLICATION INFORMATION

(76) Inventor: Richard Pickering, Suwanee, GA (US)

(21) Appl. No.: 13/470,529

(22) Filed: May 14, 2012

Related U.S. Application Data
(60) Provisional application No. 61/486,207, filed on May 13, 2011.

(51) Int. Cl. G06F 15/16

(52) U.S. Cl. 709/206

(57) ABSTRACT

Systems and methods are disclosed to replace a received message received by a communications application of a computer or a mobile phone with a replacement message that includes a time and date stamp that is approximately the same as the time and date stamp of the received message in response to input received from an input device of the computer or the mobile phone. The received message is, for example, a private, confidential, or potentially embarrassing message, and the replacement message is a message used to appear as the received message in the communications application. The replacement message can be, for example, a stored message created by the user, a message generated by the computer or the mobile phone, a message from a stored randomized list, a message requested from an outside source.

### CROSS-REFERENCE TO RELATED APPLICATIONS

This application claims the benefit of U.S. Provisional Application Ser. No. 61/486,207, filed on May 13, 2011, the content of which is incorporated by reference herein in its entirety.

### INTRODUCTION

1. Field of the Invention

Embodiments of the present invention relate generally to systems and methods for changing the information displayed on computers and mobile phones. More particularly, embodiments of the present invention relate to systems and methods that change a message received on a computer or mobile phone in response to an input device of the computer or mobile phone.

2. Background

Preventing a passerby, a friend, or a co-worker from viewing private, confidential, or potentially embarrassing information that is displayed on a computer screen has long been a problem. Solutions to this problem have included providing a keystroke or combination of keystrokes that quickly remove the private information from the screen. For example, some computer games have included a “boss button” keystroke. When this “boss button” keystroke is selected, the game pauses and displays a business application, such as a spreadsheet, on the computer screen.

The increasing use of messaging mobile phones and smart mobile phones has made the possibility of revealing private information shown on a screen even more likely. Not only are the displays of mobile phones easily viewed by others, but mobile phones are often shared among friends. In addition, the explosion in the use of communication applications on mobile phones, such as messaging, chatting, and social networking, has increased the amount of private information that is displayed on these devices. For example, a user may be showing a friend a favorite video on a smartphone, when an embarrassing message posted on another friend's social networking page arrives. Also, with a mobile phone, it may not be enough to just change the application currently displayed on the screen. If another person asks for the mobile phone to verify what they thought they saw, they can easily return to the application they saw and view the private information.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a flowchart showing a method for replacing a message received on a computer or mobile phone, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

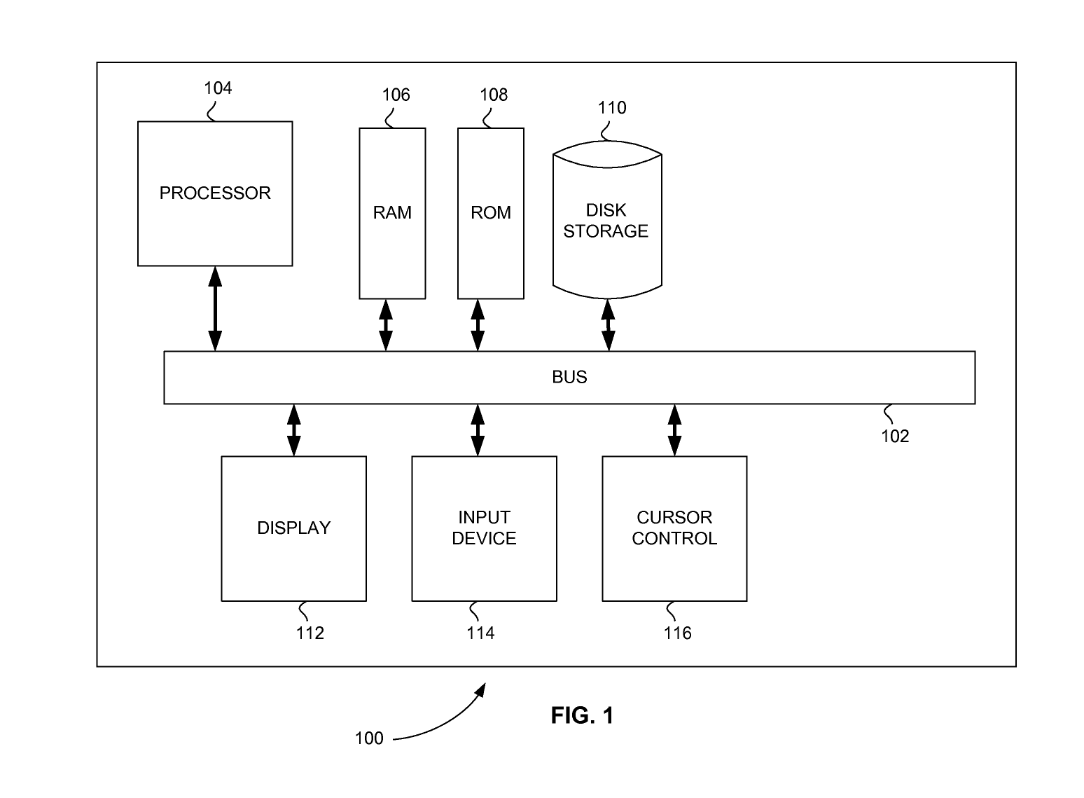

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for determining base calls, and instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software. Computer system 100 can part of any type of any personal communication device. A personal communication device can include, but is not limited to a computer, a tablet computer, a game player, a music player, a video player, or a mobile phone, or a phone.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a non-transitory and tangible computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Methods of Data Processing

As described above, the increasing use of messaging mobile phones and smart mobile phones has made the possibility of revealing private information shown on a screen even more likely. In addition, the explosion in the use of communication applications on mobile phones, such as messaging, chatting, and social networking, has increased the amount of private information that is displayed on these devices.

In various embodiments, systems and methods are used to remove, change, or replace a message received by a communications application of a computer or a mobile phone in response to input received from an input device of the computer or the mobile phone. The message can include, but is not limited to, an e-mail, a text message, a chat message, or a post from a social networking site. The communications application can include, but is not limited to, a browser, an e-mail application, a text messaging application, or a social networking application. The computer can include any type of computer capable of sending and receiving messages from a communications application including a notebook computer, an ebook reader, or a tablet computer. The mobile phone can include any type of mobile phone capable of sending and receiving messages from a communications application including a messaging phone or a smart phone. The input device of the computer or the mobile phone can include, but is not limited to, a keyboard, a keypad, a button, a microphone, a touchscreen, or a motion sensing device.

The message received by a communications application of a computer or a mobile phone generally includes a time and date stamp. Also, the communications application of the computer or mobile phone generally alerts the user to the receipt of a message through an audio signal from the device or vibration of the device, for example. As a result, a passerby, a friend, or a coworker can also be alerted to an incoming message and understands that the incoming message includes the time and date stamp that reflects approximately the same time as the alert.

In various embodiments, systems and methods are used to replace a received message received by a communications application of a computer or a mobile phone with a replacement message that includes a time and date stamp that is approximately the same as the time and date stamp of the received message in response to input received from an input device of the computer or the mobile phone. The received message is, for example, a private, confidential, or potentially embarrassing message, and the replacement message is a message used to appear as the received message in the communications application. The replacement message can be, but is not limited to, a stored message created by the user, a message generated by the computer or the mobile phone, a message from a stored randomized list, a message requested from an outside source such as a news or sports site, or a sports score.

In various embodiments, systems and methods are used to move a received message received by a communications application of a computer or a mobile phone down in the recent message queue of the communications application to effectively remove the received message from the screen. For example, adding one or messages to the communications application with a time and date stamp that is after the time and date stamp of the received message in response to input received from an input device of the computer or the mobile phone moves the received message down in the recent message queue of the communications application. The received message remains in the communications application. However, it no longer appears to be the last message received.

In various embodiments, a communications application of a computer or a mobile phone itself includes a method to remove, change, or replace a received message received by the communications in response to input received from an input device of the computer or the mobile phone.

In various embodiments, a separate software application of a computer or a mobile phone is used to remove, change, or replace a received message received by a communications application in response to input received from an input device of the computer or the mobile phone. In one example, a phone application or program allows for an individual to change an incoming text message to another message by clicking or pressing a button on the phone. The text message is changed or replaced by pressing a button on the phone, which could be the volume button on the exterior of the phone or a button on the screen, for example. The message is changed or replaced after the individual determines that the message is private, for example. In various embodiments, the message is changed or replaced just before the individual hands the phone to someone else that is suspicious of the message. In various embodiments, the message is changed or replaced in response to a spoken command received by a microphone of the phone or a movement of the phone received by a motion sensing device of the phone.

In various embodiments, the separate software application that is used to remove, change, or replace a received message received by a communications application in response to input received from an input device of the computer or the mobile phone is a client application running only on the computer or mobile phone. The client application can communicate directly with the communications application through an application programming interface (API) or through the communications channel or protocol the communications application uses, for example.

In various embodiments, the separate software application that is used to remove, change, or replace a received message received by a communications application in response to input received from an input device of the computer or the mobile phone includes both a client application running on the computer or mobile phone and a server application running on a server computer. Either the client application or the server application can communicate directly with the communications application through an application programming interface (API) or through the communications channel or protocol the communications application uses, for example. The client application can include a separate executable program or an applet of an Internet browser, for example. A server application can include web server and web site, for example. User selections can be entered using the client application or the server application.

In various embodiments, the separate software application that is used to remove, change, or replace a received message received by a communications application in response to input received from an input device of the computer or the mobile phone replaces the entire communications applications. Essentially, the separate software application mimics the display of the communications application and does not show the received message.

In various embodiments, the separate software application includes a recovery feature. After entering a password or another type of input the separate software application returns the communications application to its original state. In other words, any removed messages are returned to the communications application, and any replacement messages are removed from the communications application.

### Phone Calls

When a mobile phone user makes or receives a phone call, the mobile phone generally stores information about the phone call, even if the phone call is not completed. This information can include the phone number received or a phone number dialed. This information can also include any information the user of the mobile phone has linked to a phone number, such as name. As a result, a mobile phone user may also want to prevent a passerby, a friend, or a co-worker from viewing private, confidential, or potentially embarrassing information related to an incoming or outgoing phone call that is displayed on a screen or stored in the memory of a mobile phone.

In various embodiments, systems and methods are used to remove, change, replace, or hide a phone number or information related to a phone number in an application of a mobile phone in response to input received from an input device of the mobile phone. The phone number is, for example, the phone number of an incoming or outgoing phone call on the mobile phone. Information related to a phone number can include, but is not limited to, a name, an address, or any other information linked to phone number on a mobile phone. Information is linked to a phone number, for example, by a contact list.

For example, a user of a mobile phone may receive a phone call in the presence of another person. The other person then wants to see the number of the incoming call on the mobile phone before the call is picked up, after the call is picked up, or after the call has ended. In various embodiments, the mobile user then uses an input device of the mobile phone, as described above, to notify an application on the mobile phone to remove, change, replace or hide the phone number of the incoming call and/or any information linked to the phone number. Later the user of the mobile can notify an application on the mobile phone using the same or another input device to return the removed, changed, replaced, or hidden number, for example.

In various embodiments, a phone number of an incoming or outgoing call is changed to another phone number from a stored predetermined list. The incoming or outgoing phone is then changed to a number from the list in response to input from an input device. For example, the numbers on a cell phone are changed by clicking on the volume button on the phone. This is similar to a “Favorites” list on the phone, for example. When the volume button is selected and incoming or outgoing number is replaced with a number from the predetermined list.

For example, a predetermined list can include the phone numbers of Bob, Ralph, Dave, and Pete. A call comes in from Mary. A user clicks on the down on a volume button and it changes the call record on the phone to indicate that the call came in from Bob instead. The next time another call comes in from Mary, the user clicks the down button on the volume button and it changes the call record on the phone to indicate that the call came in from Ralph this time. The next time a call comes in from Suzy. The user clicks the down button on the volume button and it changes the call record on the phone to indicate that the call came in from Dave this time. Then a call comes in from a flower shop. The user clicks the down button on the volume button and it changes the call record on the phone to indicate that the call came in from Pete this time. The list then repeats. The next call comes in from a credit card company. The user clicks the down button on the volume button and it starts the list over again and changes the call record on the phone to indicate that the call came in from Bob.

In various embodiments, a real phone log is replaced by a user generated phone log when an input device of the phone receives an input. For example, each time a call is sent or received a user generated phone log is created with an item replacing the real call. The real call can be replaced from a predetermined list as described above, for example. Then, when a user clicks the down button on the volume control of a phone, for example, the real phone log is replaced with the user generated phone log.

In various embodiments, the user can view or return the real phone log by using an input device or entering a userid and password. For example, a click on the volume button once changes log. A click on the down volume button twice and the up volume button once the returns the real phone log. A user can also set the toggle control sequence just like changing a password, for example. In various embodiments, any real communications log is replaced by a user generated communications when an input device of the phone receives an input. A communications log can include, but is not limited to, a phone, text, or email log.

### Automatic Replacement

In various embodiments, incoming or outgoing communications from a personal communication device are removed, changed, replaced, or hidden automatically without receiving input from an input device. For example, an application allows a user to create a replacement contact list. This replacement contact list includes one or more numbers, addresses, and/or messages to be used to replace a real phone number, address, and/or message. Whenever a communication is sent or received the application searches the replacement contact list for information related to the communication. If any information is found to match the communication, that information is removed, changed, replaced, or hidden according to the information in the replacement contact list.

In various embodiments, a replacement contact list can include replacement information for any communication not on the list. For example, any unknown communications received or sent can be replaced with information stored on the contact list for new or unknown communications.

The application can be a client application, a server application, or a combination of a client and a server application. The replacement contact list can be stored on a client, a server, or both a client and server.

In various embodiments, an automatic system for removing, changing, replacing, or hiding communications is used in conjunction with an input from an input device. For example, as described above, an application can automatically create a communications replacement log. An application can then replace a real communications log with the replacement communications log in response to input from an input device.

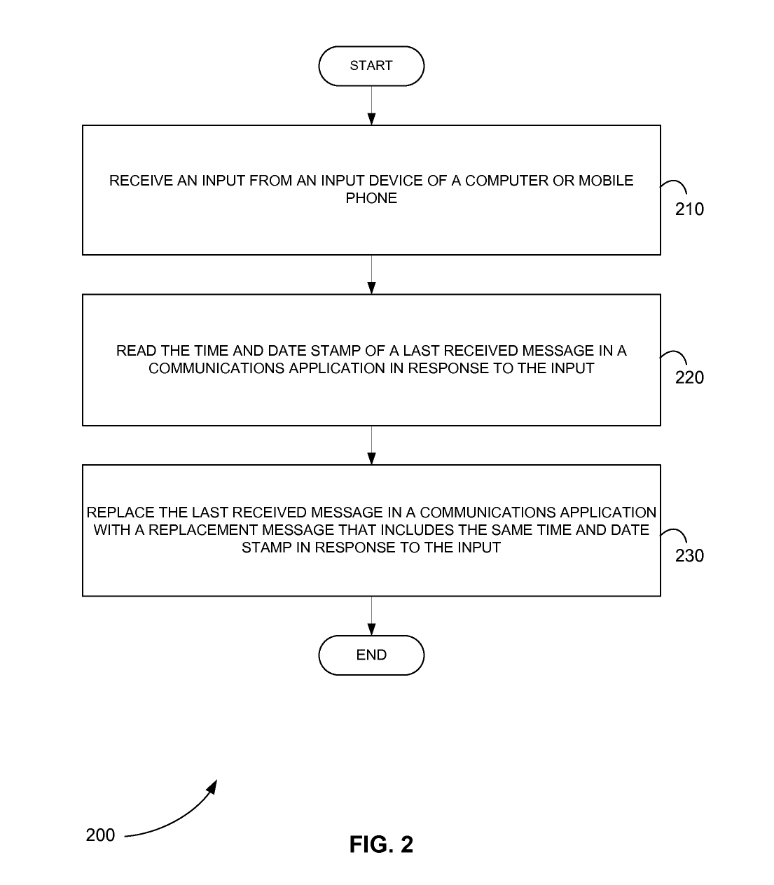

FIG. 2 is a flowchart showing a method 200 for replacing a message received on a computer or mobile phone, in accordance with various embodiments.

In step 210 of method 200, an input is received from an input device of the computer or mobile phone.

In step 220, the time and date stamp of a last received message in a communications application is read in response to the input.

In step 230, the last received message in the communications application is replaced with a replacement message that includes the same time and date stamp in response to the input.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A method for replacing a message received on a computer or mobile phone, comprising:
receiving an input from an input device of the computer or mobile phone;
reading the time and date stamp of a last received message in a communications application in response to the input; and
replacing the last received message in the communications application with a replacement message that includes the same time and date stamp in response to the input.

2. The method of claim 1, wherein the replacement message is one or more of a stored message created by the user, a message generated by the computer or mobile phone, a message from a stored randomized list, or a message requested from an outside source.

3. The method of claim 1, further comprising moving the last received message down in a recent message queue of the communications application to effectively remove the last received message from a screen.

4. The method of claim 1, wherein the last received message is replaced in response to an input received from the input device, and wherein the input comprises clicking or pressing a button on the computer or mobile phone.

5. The method of claim 1, wherein the last received message is replaced in response to a spoken command received by a microphone of the computer or mobile phone.

6. The method of claim 1, wherein the message is received on a mobile phone, and wherein the last received message is replaced in response to a movement of the mobile phone received by a motion sensing device of the mobile phone.
